(19) United States
(12) Patent Application Publication
(10) Pub. No.: US 2006/0047727 A1
(43) Pub. Date: Mar. 2, 2006

(54) Method of accessing a file for editing with an application having limited access permissions

(76) Inventors: Alan H. Karp, Palo Alto, CA (US); Mark S. Miller, Cupertino, CA (US); Marc D. Stiegler, Kingman, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/928,188

(22) Filed: Aug. 30, 2004

(51) Int. Cl. G06F 17/30

(52) U.S. Cl. 707/205

(57) ABSTRACT

A method for accessing a file for editing includes limiting access permissions of an application to one or more directories including a first directory and receiving a request to edit the file stored in a second directory using the application. The second directory is not included in the one or more directories available to the application. The file is copied from the second directory to the first directory.

### BACKGROUND

In the past few years, computer viruses have caused damage to processing systems throughout the world. A computer virus is a program capable of operation on a system, such as a personal computer, that is self-replicating and that can “infect” other programs by modifying them or their environment such that a call to an infected program results in an action that the user may not like. Detection, identification, and handling of computer viruses are the focus of commercial software products called “anti-virus” programs.

These anti-virus programs typically scan files on a processing system word-by-word or byte-by-byte to detect a virus by identifying a “signature string” of digital values in a file. The detection of a particular signature string indicates that identifiable virus code is present in the file. Once the virus is detected and identified, the anti-virus program responds in one of several ways. The anti-virus program may simply delete the file from the computer system, thereby removing the virus, but this action also destroys the file's original contents. Alternatively, the anti-virus program may attempt to “clean” the infected file by removing virus code from the file. However, if a virus is detected in error, for instance, a false positive is indicated by the anti-virus program, or the wrong bytes in the file are overwritten, then the attempt to clean the infected file results in the partial destruction of the original file.

Computer systems today typically run operating systems having user accounts for users of the systems. A user logs into the computer system under a user account and has permissions to add, edit, delete or use most of the resources available in the computer system. Additionally, applications running in the user's account have the same permissions as the user. This arrangement presents a computer virus with a doorway to most of the resources in the computer system. For instance, if an application is infected by a virus, the virus is able to spread to any resource that the application may access. In effect, the virus has the same permissions as the user and is able to add, edit, delete or use most of the resources available in the computer system. For example, the virus could use e-mail resources to spread itself to every other user listed in the user's e-mail address book. The virus could also delete important system files making the computer system inoperable. Conventional anti-virus programs typically cannot control the spread of a virus until it is detected.

### SUMMARY

In an embodiment, a method for a accessing a file for editing is disclosed. The method includes limiting access permissions of an application to one or more directories including a first directory and receiving a request to edit the file stored in a second directory using the application. The second directory is not included in the one or more directories available to the application. The method also includes the step of copying the file from the second directory to the first directory.

### BRIEF DESCRIPTION OF THE DRAWINGS

Embodiments of the invention are illustrated by way of example and without limitation in the accompanying figures in which like numeral references refer to like elements, and wherein:

FIG. 1 shows a Venn diagram of user accounts in accordance with an embodiment of the invention;

FIG. 2 shows a table of user account permissions in accordance with an embodiment of the invention;

FIG. 3 shows a block diagram of a system for copying and monitoring files in accordance with an embodiment of the invention;

FIG. 4 shows a flow diagram of an operation mode of a method of accessing a file for editing in accordance with an embodiment of the invention;

FIG. 5 shows a flow diagram of an operation mode of creating a script for designating a file for copying and monitoring in accordance with an embodiment of the invention;

FIG. 6 shows a flow diagram of an operation mode of a program for copying and monitoring a file in accordance with an embodiment of the invention;

FIG. 7 shows a flow diagram of an operation mode of a program for copying and monitoring a file in accordance with another embodiment of the invention;

FIG. 8 shows a schematic diagram of a word processor running in a user account in accordance with an embodiment of the invention;

FIG. 9 shows a schematic diagram of the word processor in FIG. 7 after a user has selected a control for adding a file to be edited; and

FIG. 10 shows a schematic diagram of a computer system in which embodiments of the invention may be implemented.

### DETAILED DESCRIPTION

For simplicity and illustrative purposes, the principles of the invention are described by referring mainly to examples thereof. In the following description, numerous specific details are set forth in order to provide a thorough understanding of the invention. It will be apparent however, to one of ordinary skill in the art, that the invention may be practiced without limitation to these specific details. In other instances, well known methods and structures have not been described in detail so as not to unnecessarily obscure the invention.

According to an embodiment, the principle of least authority (hereinafter referred to as POLA) is implemented by a system for controlling an application's access to resources within a computer system. POLA, in general, gives a person or thing the least authority it needs to perform a task. By implementing POLA in the computer system, the system controls an application's access (i.e., permissions) to resources within the computer system. In one example, the system may control an application's access to the resources such that the application may have access to only the executable file needed to run the application and any other file necessary to complete a task. By controlling the access to resources, the computer system can be shielded from an application infected with a virus. For example, the virus may only be able to spread to the limited resources that the application may access.

In one embodiment, an application's permissions to resources are limited by running the application in a restricted user account. For example, a restricted user account is created, which has access to at least one but not all of the resources in the computer system, such as the resources needed by the application to run, and the application is executed in the restricted user account. Then, the application can only access the resources that the restricted user account can access. For purposes of describing the embodiments, an application running in a restricted user account is referred to as an endowed application.

As described above, an application's access to resources within a computer system may be limited to minimize the spreading of viruses. Broadly, resources may include any component of a computer system or any component accessible by a computer system. One example of limiting a resource includes limiting access permissions. Access permissions, as used in the present disclosure, includes read and/or write permissions. Examples of limiting access permissions for an application include granting read-only permission to a file in a directory, granting read and write permissions to particular directories and not granting any access permissions to other directories, etc.

For example, a word processing application may be installed and configured to run in a restricted user account having access to only the files needed to run the application and one or more directories for holding files to be edited by the word processor. The word processing application running in the restricted user account is an endowed application. The resources of the endowed application may include files, e-mail address books, network connection, or the like and are determined when the application is installed on the computer system. Access permissions for the application may be limited by only granting the user account access permissions to an executable file which started the endowed application and a directory storing files used by the application. In another example, the endowed application may have access to a file, a set of files, all files in a directory, all files in a set of directories and/or a network connection.

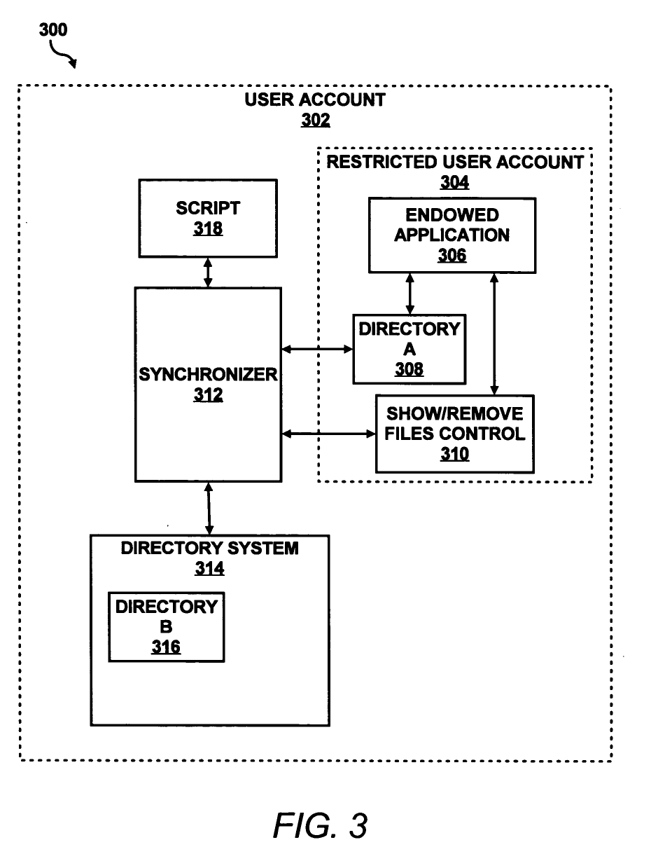

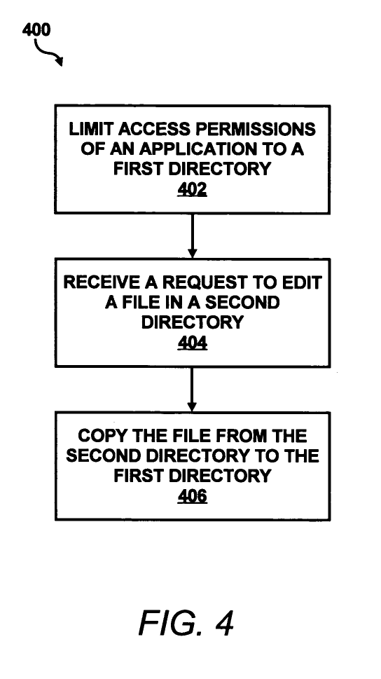

In another example, an endowed application is running on a computer system. The endowed application has limited access permissions, such as read only access to an executable file which started the application, read access to a directory or directories containing support files necessary for running the endowed application and read/write access to at least a first directory designated for holding files to be edited by the endowed application. If the endowed application was infected with a virus, the virus may attack only the files within the first directory which is usually empty until a user designates a file for editing, such as described in detail below with respect to FIGS. 3 and 4. The remaining resources of the computer system not accessible by the endowed application are protected from attack by the virus. For example, the virus is restricted to installing any software only in the first directory and may not install software in other directories of the computer system. Additionally, the files located in the first directory may be protected if the endowed application only has read access to those files. This arrangement provides significant advantages to a user of the computer system because infected programs are isolated, which isolates any damage caused by the virus. The user may lose files stored in the first directory but not all files the virus intended to attack. Upon detection of the virus, the user may simply delete the infected program and reinstall a clean copy of the program. Alternatively, in the case of a macro virus, the user may delete the infected file or remove the macro from the file.

In an example, a user may designate a file to be copied to the first directory by creating a script associated with the file. The user may run a script generator to generate a script responsible for sending a request to a program for copying an original file to the first directory from a second directory and monitor the file for any changes. If a change is detected, the program replaces the original file in the second directory with the changed copy in the first directory.

In another example, a user may designate a file to be copied to the first directory using the endowed application, which may be modified from the original version to include additional controls. The controls may be clickable buttons, menu options, hotkeys, or the like. The additional controls are configured to send requests to the program. The program accepts the requests, asks the user what to do, copies a selected original file from the second directory to the first directory and monitors the copied file for any changes. If a change is detected, the program replaces the original file with the changed copy. By this configuration, use of the endowed application is simplified. For instance, a user of the endowed application learns about the additional control or controls and may use the application normally without additional training. The learning curve is, therefore, significantly reduced or eliminated. Additionally, the user takes one or two extra steps when accessing a resource not originally available to the endowed application thus reducing the complexity of using the protected system. Therefore, the user is more likely to use this protection and thus reduce the spread of virulent viruses saving the user and the entire community of computer users the costs associated with virus attacks.

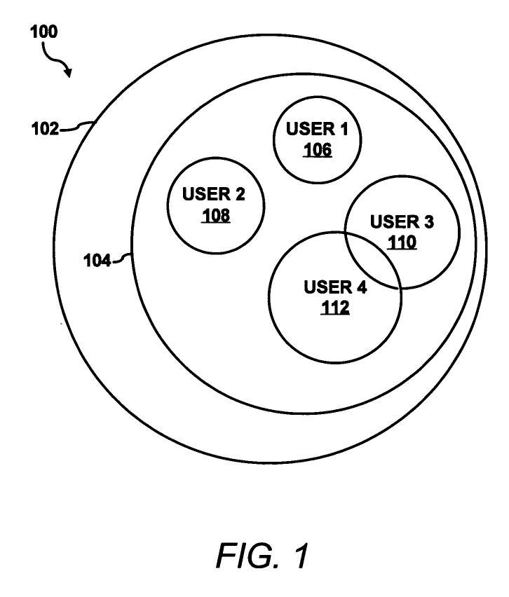

With reference first to FIG. 1, there is shown a Venn diagram 100 of user accounts in accordance with an example of a computer system. An administrative account 102 may have access to all resources available in a computer system while a user account 104 may have access to all resources available to that particular user. User accounts typically have access to fewer resources than the administrative account 102. However, many user accounts may have access to all resources available in a computer system thus increasing the need for additional protections. The Venn diagram 100 also includes four smaller circles representing four user accounts 106-112 having access to a predetermined set of resources. The first user account 106 has access to the fewest number of resources. For example, the first user account 106 may have access to a single executable file or application. The second user account 108 has access to more resources while the third user account 110 has access to even more resources. In the Venn diagram 100, the forth user account 112 has access to the most systems resources although access is limited to a subset of the resources available to the user which itself is a subset of resources available in the computer system.

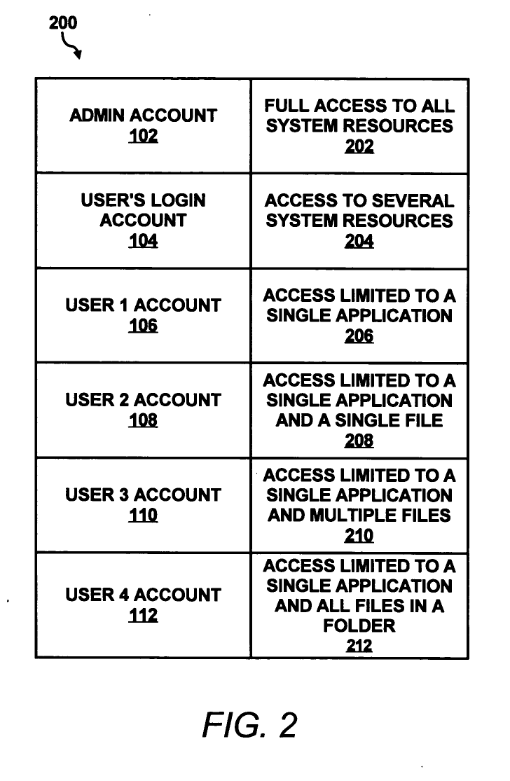

FIG. 2 shows a table 200 of user account permissions in accordance with the Venn diagram of FIG. 1. The administrative account 102 has access to all systems resources, shown in entry 202, in the computer system. The user account 104, or the user's login account, has access to several system resources, shown in entry 204. The system resources may be designated by the administrator of the system. For example, the administrator may determine that a particular user needs access to all text files in certain directories but should not have access to any files containing financial information while an administrator of a company should have access to any file containing financial information but not have access to any file containing confidential client information. The administrator may designate permissions to user accounts accordingly.

The permissions may be recorded and stored as a list of resources. The list of resources may be stored in a table, database or any data structure that may be used to store data. The list of resources identifies the resources available to one or more user accounts. One example of a list of resources is an access control list. The access control list includes entries identifying the resources in a computer system, the user accounts in the computer system, and permissions of the user accounts to access the resources. That is, the access control list maintains a list of resources available to each user account in the computer system.

The first user account 106 has access to a single application, shown in entry 206. The first user account 106 may have been created to run a single executable file, such as, a game, calculator or any other program that runs as a single application. The second user account 108 has access to a single application and a single file, shown in entry 208. The second user account 108 may have been created to run a word processor and access one text file. The third user account 110 has access to a single application and multiple files, shown in entry 210. The third user account 110 may have been created to run a spread sheet program with access to particular spread sheet files located on the computer system. The fourth user account 112 has access to a single application and all files in a particular directory, shown in entry 212. The fourth user account 1 12 may have been created to run a word processor and access all files in a user directory. The description of the user accounts above are for illustrative purposes only. One of ordinary skill in the art would recognize that the any number of user accounts may be created having a plurality of possible permission settings. For instance, multiple restricted user accounts may be designated for multiple instances of an application. That is multiple instances of the same application may be simultaneously running on the same computer system. For example, a first instance may be started by a user double-clicking on an icon for the application, and while the first instance is running, the user may double-click on the icon again which starts a second instance of the application. Each instance runs in its own restricted user account. For example, one restricted user account may be designated for a first instance of an endowed application having access to a first file while another restricted user account may be designated for a second instance of an endowed application having access to a second file. In this arrangement, a virus attacking the first instance of the endowed application would not affect or corrupt the second file.

In one example, the user accounts 106-112 may be accounts for the same user of the user account 104. However, the user accounts 106-112 were created to run the applications described above in an environment where the applications have access to limited resources instead of all the resources of the user account 104. Thus, a virus infecting any of the applications is substantially confined to the resources available to the infected application.

Referring now to FIG. 3, there is shown a block diagram of a system for copying and monitoring files in accordance with an example of a computer system 300. The computer system 300 includes a user account 302 having included therein a restricted user account 304. The restricted user account 304 is designated to run an endowed application 306 and access a first directory. In this example, the first directory is directory A, labeled 308. The endowed application 306 may include a show/remove files control 310. A synchronizer 312 also runs in the user account 302 and also has access to a directory system 314 including a second directory. In this example, the second directory is directory B, labeled 316. A script 318 is also available through the user account 302.

The endowed application 306 runs within the restricted user account 304 and accesses files necessary to run the application and the directory A 308. The synchronizer 312 runs within the user account 302 and is responsible for copying files between the directory B 316 and the directory A 308. The synchronizer 312 is also responsible for monitoring files copied into directory A 308. When a file in directory A, 308 changes, the synchronizer 312 copies the changed file into directory B, 316. The synchronizer 312 accepts requests to copy and monitor files from either a script 318 created on behalf of the user or a show/remove files control 310 selected by a user. Either way, the user requests that the synchronizer 312 copy and monitor a file from the directory B 316 to the directory A 308 so that the user may edit the file with the endowed application 306.

The synchronizer 312 is a program or application configured to run in a user account 302 separate from the restricted user account 304 designated for the endowed application 306. The synchronizer 312 has access to the directories associated with the endowed application 306 and other directories in the computer system. The synchronizer 312 receives requests from a user to copy an original file from a directory not available to the endowed application 306 to a directory available to the endowed application 306. The synchronizer 312 also monitors the copied files in the directory or directories available to the endowed application 306 and updates the associated original file when the copy is changed by the endowed application 306.

FIG. 4 shows a flow diagram of an operational mode 400 of a method of accessing a file for editing. The following description of the operational mode 400 is made with reference to the system 300 illustrated in FIG. 3, and thus makes reference to the elements cited therein. The following description of the operational mode 400 is one manner in which a file may be accessed for editing. In this respect, it is to be understood that the following description of the operational mode 400 is but one manner of a variety of different manners in which the method may be implemented.

At step 402, a user limits the access permissions of an application to one or more directories. For example, access permissions for the application, which may include an endowed application, are limited to a first directory. Limiting the access permissions may include other steps such as identifying an application, determining the access permissions for the application, creating a restricted user account 304 and starting the application in the restricted user account 304. In this manner, the endowed application 306 is created.

At step 404, the synchronizer 312 receives a request to edit a file in a second directory. The synchronizer 312 copies the file from the second directory to the first directory at step 406. A copy of the file is now in the first directory and may be accessed and edited by the application.

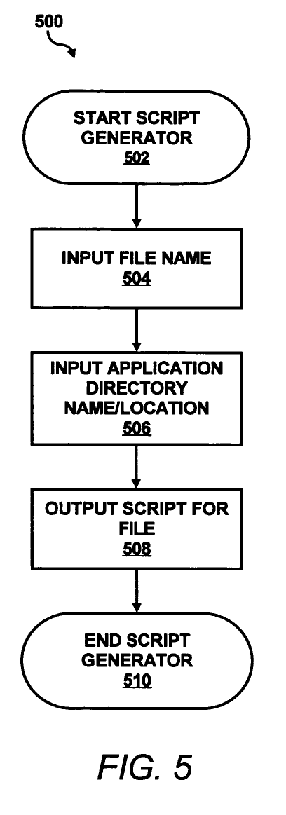

FIG. 5 shows a flow diagram of an operational mode 500 of a program creating a script for designating a file for copying and monitoring in accordance with an example of a computer system. The following description of the operational mode 500 is made with reference to the system 300 illustrated in FIG. 3, and thus makes reference to the elements cited therein. The following description of the operational mode 500 is one manner in which the script 318 may be created. In this respect, it is to be understood that the following description of the operational mode 500 is but one manner of a variety of different manners in which such a system may be operated.

In the operational mode 500, a user starts a script generator in step 502. The script generator accepts as inputs a file name to be edited by the endowed application 306 in step 504. The script generator also accepts as inputs the name of the endowed application and the name and location of directory A, 308 in step 506. The script generator outputs a script 318 for the file to be edited by the user in step 508. Finally, the script generator ends in step 510. For example, the user may run the script generator to create a script associated with a word processor file. The user runs the script generator, identifies the file to be edited and identifies the application to edit the file along with the associated name and location of the directory in which the application has access. The script generator generates a script for the user. When the user desires to edit the file, the user selects and runs the script which starts the endowed application 306 and sends a request to the synchronizer 312 to handle the copying and monitoring.

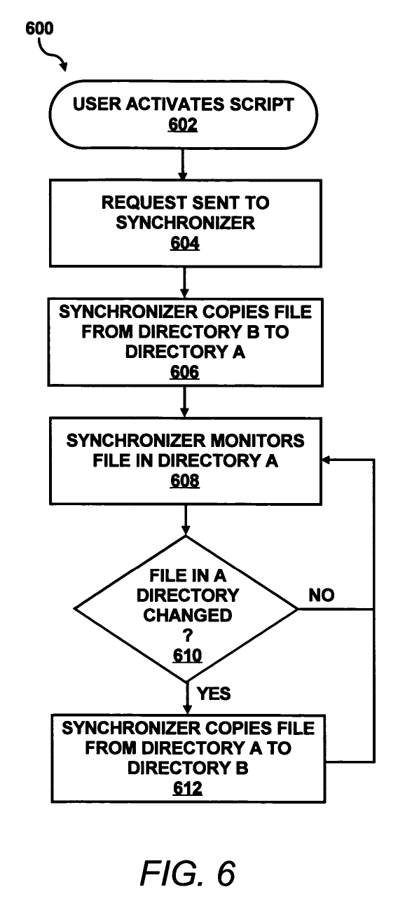

FIG. 6 shows a flow diagram of an operational mode 600 of a program for copying and monitoring a file in accordance with an example of a computer system. The following description of the operational mode 600 is made with reference to the system 300 illustrated in FIG. 3, and thus makes reference to the elements cited therein. The following description of the operational mode 600 is one manner in which the system 300 may be implemented. In this respect, it is to be understood that the following description of the operational mode 600 is but one manner of a variety of different manners in which such a system may be operated.

In the operational mode 600, a user activates the script 318 in step 602. The script 318 may have the same name as the file except for the extension and may be configured to launch the endowed application 306. The script 318 sends a request to the synchronizer 312 in step 604. The request includes the name of the file to be copied and monitored and the location accessible by the endowed application 306, which will edit the file. The synchronizer 312 then copies the file from directory B, 316 to directory A, 308 in step 606. The synchronizer 312 monitors the file in directory A,308 in step 608. The synchronizer 312 checks to determine if the copied file in directory A, 308 has changed in step 610. If no, the synchronizer 312 continues to monitor the file in directory A, 308. If yes, the synchronizer 312 copies the file from directory A, 308 to directory B, 316 in step 612. At this point the synchronizer 312 returns to step 608 and continues to monitor the file. For example, the script 318 (client.bat) may have been created for a word processor (word.exe) text file (client.txt). Alternatively, the script 318 may be a generic script that takes the name of the text file (client.txt) and the name of the endowed application (word.exe) as arguments. The script 318 runs the word processor program (word.exe) and sends a request to the synchronizer 312 to copy the file “client.txt” to one of the directories or folders available to the program “word.exe.” Now the word processing program may access and edit the copy of the file “client.txt.” The synchronizer 312 monitors the file for any changes and overwrites the changes made to the file back to the original file “client.txt.”

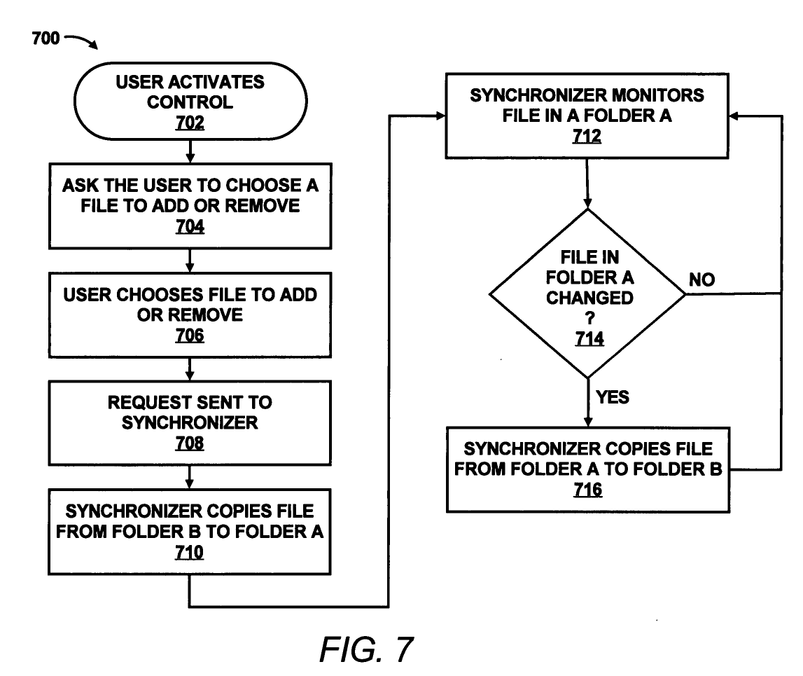

FIG. 7 shows a flow diagram of an operational mode 700 of a program for copying and monitoring a file in accordance with another example of a computer system. The following description of the operational mode 700 is made with reference to the system 300 illustrated in FIG. 3, and thus makes reference to the elements cited therein. The following description of the operational mode 700 is one manner in which the system 300 may be implemented. In this respect, it is to be understood that the following description of the operational mode 700 is but one manner of a variety of different manners in which such a system may be operated.

In the operational mode 700, the endowed application 306 is running and a user requests a modification to a list of files that the application has permission to access in step 702. For example, the user activates a control 310 in the endowed application 306. With reference to the example above, the user, while using the application “word.exe”, may select a button or entry in a pop-up menu to request the addition or removal of a file to the directory or folders accessible by the endowed application 306. Next, a dialog box appears asking the user to choose a file to add or remove from the directory or directories available to the endowed application 306 in step 704. The user then chooses a file to add or remove in step 706. A request is sent to the synchronizer 312 to copy and monitor the chosen file in step 708. The request includes the name of the file to be copied and monitored and the location accessible by the endowed application 306 which will edit the file. The synchronizer 312 then copies the file from directory B, 316 to directory A, 308 in step 710. The synchronizer 312 monitors the file in directory A, 308 in step 712. The synchronizer 312 checks to determine if the copied file in directory A, 308 has changed in step 714. If no, the synchronizer 312 continues to monitor the file in directory A, 308. If yes, the synchronizer 312 copies the file from directory A, 308 to directory B, 316 in step 716. At this point the synchronizer 312 returns to step 712 and continues to monitor the file.

Some of the steps illustrated in the operational modes 500, 600 and 700 may be contained as a utility, program, subprogram, in any desired computer accessible medium. In addition, the operational modes 500, 600 and 700 may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

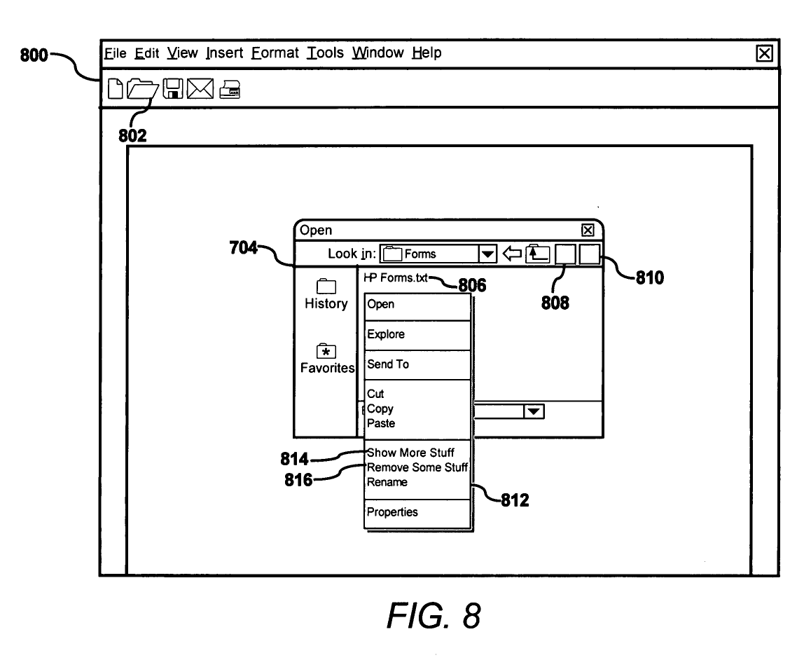

Referring now to FIG. 8, there is shown a schematic diagram of a word processor 800 running in the computer system 300. The word processor 800 includes an open file control 802. Upon selecting the open file button 802, the word processor presents an open dialog box 804 to the user. As shown, only a single file 806 is available for opening to the user. The file 806 was copied to the directory by the synchronizer 312 by a request from either the script 318 or the show/remove file control 310. The word processor 800 has been endowed and given access to a directory including the single file 806. The open dialog box 804 also includes two controls, a control 808 for adding more files to the directory and a control 810 for removing files from the directory, which are examples of the implementation of the show/remove file control 310. These controls 808 and 810 may be labeled as a “show more stuff” control 808 and a “remove some stuff” control 810. Alternatively or in addition, the show more stuff control 808 and remove some stuff control 810 may be presented to the user through a pop-up menu 812 represented by reference numbers 814 and 816, respectively.

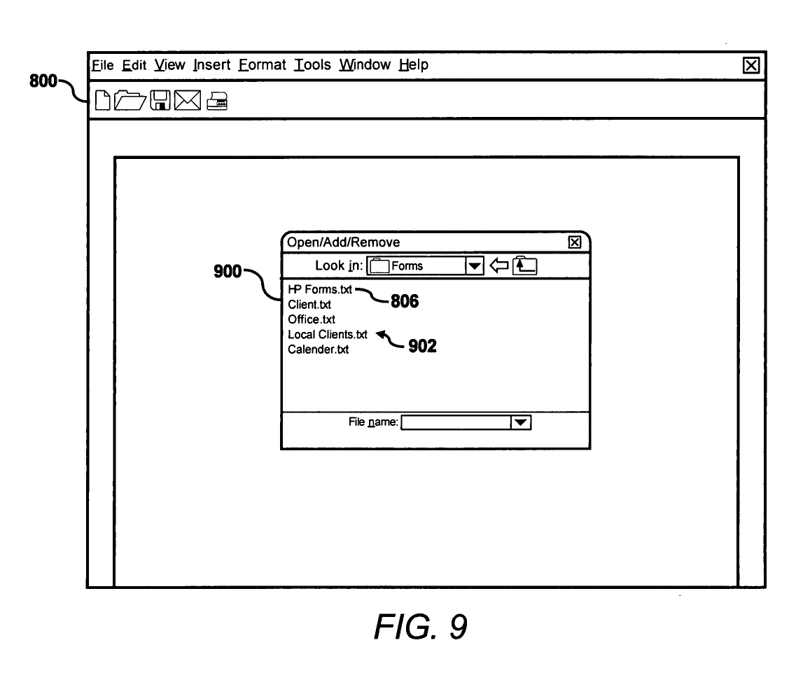

When a user selects the show more stuff control 808 or 814, a request is sent to the synchronizer 312 which presents the user with another dialog box 900 shown in FIG. 9. This dialog box 900 displays to the user files 902 that may be added to or removed from the files in the directory available to the word processor 800. When a user selects one of the files 902, that file is copied to the directory available to the word processor 800 and appears in the open dialog box 804. For example, the file 806 shown in FIG. 8 is added as available for the word processor 800 by selecting the file 806 from the dialog box 900 shown in FIG. 9.

When a user selects the remove some stuff control 810 or 816, the user is presented with the same dialog box 900 shown in FIG. 9. A different dialog may be presented for each function, such as a different dialog box for each of the add resources function and the remove resources function. For purposes of illustration, a single dialog box 900 is shown where the user may add or remove resources for the word processor 800. The dialog box 900 displays files that may be removed from the directory available to the word processor 800. When a user selects a file from the list shown in the dialog box 900, such as the file 806 and the file 806 is deleted from the directory, the file 806 becomes unavailable to the word processor 800 and does not appear in the open dialog box 804. That is, the user cannot access the file 806 through the word processor 800.

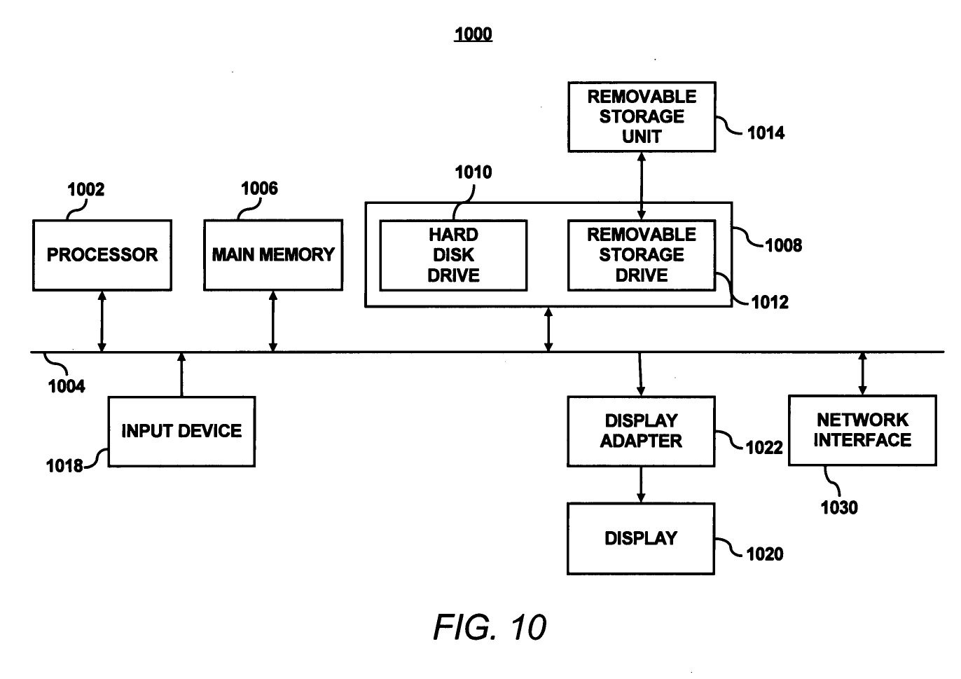

FIG. 10 illustrates an exemplary block diagram of a computer system 1000 that may run the word processor 800 shown in FIGS. 8 and 9. The computer system 1000 includes one or more processors, such as processor 1002, providing an execution platform for executing software, such as the word processor 800, the synchronizer 312 and script 318. The processor 1002 may also execute an operating system (not shown) for running the word processor, creating and managing user accounts including permissions for the user accounts, etc.

Commands and data from the processor 1002 are communicated over a communication bus 1004. The computer system 1000 also includes a main memory 1006, such as a Random Access Memory (RAM), where software may be executed during runtime, and a secondary memory 1008. The secondary memory 1008 includes, for example, a hard disk drive 1010 and/or a removable storage drive 1012, representing a floppy diskette drive, a magnetic tape drive, a compact disk drive, etc., or a nonvolatile memory where a copy of the software may be stored. Applications and some resources, such as files, may be stored in the secondary memory 1008 and transferred to the main memory 1006 during run time. Additionally, the synchronizer 312, script 318, files and directories 308 and 316 may be stored in the same manner. The secondary memory 1008 may also include ROM (read only memory), EPROM (erasable, programmable ROM), EEPROM (electrically erasable, programmable ROM).

A user interfaces with the computer system 1000 with one or more input devices 1018, such as a keyboard, a mouse, a stylus, and the like. The display adaptor 1022 interfaces with the communication bus 1004 and the display 1020 and receives display data from the processor 1002 and converts the display data into display commands for the display 1020. The user interacts with the application, resources, synchronizer, endowed application and scripts through the use of the input devices 1018 and display 1020. A network interface 1030 is provided for communicating with other nodes via a network.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which intended to be defined by the following claims and their equivalents in which all terms are meant in their broadest reasonable sense unless otherwise indicated.

What is claimed is:

1. A method for accessing a file for editing, the method comprising:
limiting access permissions of an application to one or more directories, the one or more directories including a first directory;
receiving a request to edit the file using the application, wherein the file is stored in a second directory, the second directory not being included in the one or more directories; and
copying the file from the second directory to the first directory.

2. The method of claim 1, further comprising monitoring the file in the first directory to detect a change in the file.

3. The method of claim 2, further comprising copying the file from the first directory to the second directory when a change is detected.

4. The method of claim 1, further comprising creating the first directory when the application runs.

5. The method of claim 4, further comprising deleting the first directory when the application is closed.

6. The method of claim 1, further comprising running a program operable to receive the request to edit the file and copy the file from the second directory to the first directory.

7. The method of claim 6, further comprising creating a script operable to send the request to the program.

8. The method of claim 7, further comprising running the script when the file is selected for editing by a user.

9. The method of claim 6, further comprising displaying a dialog box showing contents of the second directory.

10. The method of claim 9, further comprising selecting a control in the application to generate the dialog box.

11. The method of claim 9, further comprising sending the request to edit the program in response to a user selecting the file from the contents of the second directory.

12. The method of claim 1, further comprising starting a second instance of the application in a restricted user account that does not have access to the one or more directories.

13. The method of claim 12, further comprising:
limiting access permissions of the second instance of the application to one or more directories for the restricted user account, wherein the restricted user account only has access to the one or more directories for the restricted user account;
receiving a request to edit the file using the second instance of the application, wherein the file is stored in the second directory, the second directory not being included in the one or more directories for the restricted user account; and
copying the file from the second directory to another directory, the another directory being included in the one or more directories for the restricted user account.

14. The method of claim 13, further comprising copying the file from the another directory to the first directory in response to detecting an edit to the file or the file being closed.

15. A system for editing a file in a first directory, the system comprising:
means for limiting an application to access a predetermined directory;
means for copying the file from the first directory to the predetermined directory;
means for monitoring changes in the file located in the predetermined directory; and
means for copying the file from the predetermined directory to the first directory upon detecting a change in the file.

16. The system of claim 15, further comprising means for creating the predetermined directory.

17. The system of claim 15, further comprising means for requesting copying of the file from the first directory to the predetermined directory.

18. The system of claim 15, further comprising means for displaying contents of the first directory to a user.

19. The system of claim 18, further comprising means for allowing a user to select the file from the contents of the first directory.

20. The system of claim 15, further comprising means for starting a second instance of the application in a restricted user account which does not have access to the predetermined directory.

21. The system of claim 20, further comprising means for limiting the second instance of the application to access a second predetermined directory and means for copying the file from the first directory to the second predetermined directory.

22. The system of claim 21, further comprising means for monitoring changes in the file located in the second predetermined directory and means for copying the file from the second predetermined directory to the first directory upon detecting a change in the file.

23. A computer readable medium on which is embedded one or more computer programs, said one or more computer programs implementing a method for editing a file in a first directory with an application having access to a predetermined directory, said one or more computer programs comprising a set of instructions for:
receiving a request to edit the file with the application;
copying the file from the first directory to the predetermined directory in response to the request;
determining whether the file in the predetermined directory has been modified; and
copying the file from the predetermined directory to the first directory when the file has been modified.

24. The computer readable storage medium according to claim 23, the one or more computer programs further comprising a set of instructions for creating the predetermined directory.

25. The computer readable storage medium according to claim 23, the one or more computer programs further comprising a set of instructions for creating the request to edit the file.

26. The computer readable storage medium according to claim 23, the one or more computer programs further comprising a set of instructions for displaying a dialog box showing contents of the first directory.

27. The computer readable storage medium according to claim 26, wherein the one or more computer programs further comprises a set of instructions for creating the request to edit the file in response to a user selecting the file from the contents of the first directory.

28. The computer readable storage medium according to claim 26, wherein the one or more computer programs further comprises a set of instructions for displaying a control in the application and displaying the dialog box in response to a user selecting the control.

29. The computer readable storage medium according to claim 23, the one or more computer programs further comprising a set of instructions for running a second instance of the application, the second instance of the application having access to a second predetermined directory and not the predetermined directory.

30. The computer readable storage medium according to claim 29, the one or more computer programs further comprising a set of instructions for receiving a request to edit the file with the second instance of the application and copying the file from the first directory to the second predetermined directory in response to the request.

31. The computer readable storage medium according to claim 30, the one or more computer programs further comprising a set of instructions for determining whether the file in the first predetermined directory has been modified and copying the file from the first predetermined directory to the first directory when the file has been modified.

32. A computer system comprising:
a restricted user account operable run an application on the computer system and access files in a predetermined directory of the computer system;
a file located in a first directory not accessible by the user account;
a program for copying the file located in the first directory to the predetermined directory, wherein the application is operable to edit the file.

33. The system of claim 32, wherein the predetermined directory is a temporary directory created by the application.

34. The system of claim 32, wherein the program is further operable to monitor changes of the file in the predetermined directory.

35. The system of claim 32, wherein the program is further operable to copy the file from the predetermined directory to the first directory when the file is changed.

36. The system of claim 32, further comprising a script for sending a request to the program for copying the file from the first directory to the predetermined directory.

37. The system of claim 36, wherein the script is run when the file is selected.

38. The system of claim 32, wherein the application further comprises a dialog box showing contents of the first directory.

39. The system of claim 38, wherein the application further comprises a control selectable by the user for displaying the dialog box.

40. The system of claim 39, wherein the application further comprises a pop-up menu having the control.

41. The system of claim 32, further comprising a second user account permitted to run a second instance of the application on the computer system and access files in a second predetermined directory of the computer system, the second predetermined directory being different from the predetermined directory.

42. The system of claim 41, wherein the second user account is not permitted to access the first directory.

43. The system of claim 42, wherein the program is configured for copying the file located in the first directory to the second predetermined directory, wherein the application is operable to edit the file.
